(19) United States
(12) Patent Application Publication
(10) Pub. No.: US 2013/0304582 A1
(43) Pub. Date: Nov. 14, 2013

(54) SYSTEM AND METHOD FOR PROVIDING A PLATFORM FOR PRIVATE REFERRALS AMONG SOCIAL CONTACTS

(71) Applicants: David Scott Beazley, Chicago, IL (US); Lester Teichner, Chicago, IL (US); Doris Jean Ayres, Chicago, IL (US)

(72) Inventors: David Scott Beazley, Chicago, IL (US); Lester Teichner, Chicago, IL (US); Doris Jean Ayres, Chicago, IL (US)

(21) Appl. No.: 13/839,255

(22) Filed: Mar. 15, 2013

Related U.S. Application Data
(60) Provisional application No. 61/613,831, filed on Mar. 21, 2012.

(51) Int. Cl. G06Q 30/02

(52) U.S. Cl. CPC G06Q 30/0251
USPC 705/14.64; 705/14.49; 705/14.66

(57) ABSTRACT

A system and method are provided for enabling a brand owner to generate, via a template, promotions such that an endorser may engage a gateway to those promotions to disseminate referrals to selected contacts within a trusted environment. The system includes the ability to select a brand owner promotion to enter the trusted environment. The endorser selects at least one contact and parameters at the trusted environment. The trusted environment generates incentive data based on the selected parameters and displays the incentive data, normalized for contacts related to an endorser at a webpage. The trusted environment includes a messaging application to generate a personal message for a contact, including a URL, to enable the contact to enter the trusted environment. In the trusted environment, a contact interacts with incentive data of various endorsers. The endorser select may a promotion from a brand owner and disseminate referrals to selected contacts.

### CROSS-REFERENCE TO RELATED APPLICATIONS

This application claims priority from U.S. Provisional Patent Application No. 61/613,831 filed on Mar. 21, 2012, the content of which is hereby incorporated by reference.

### BACKGROUND

1. Technical Field

The present disclosure relates to referral marketing and more specifically to providing a promotional platform for referral marketing that allow owners to offer incentives to entice visitors to become endorsers to privately market products and services to contacts and to incent the contacts to redeem endorser selected offers on the endorser's personal webpage.

2. Introduction

Through blending of social interactions and technology, networks support widespread creation and exchange of content. In this landscape, advertisers continue to shift their marketing strategies by migrating toward targeted advertising that is more socially driven. User information obtained by culling search engine queries may be supplemented by databases to provide additional personal information, such as occupation, age, brand preferences, hobbies, relationships, online comments, browsing history, purchase history, and the like. Advertisers may use this personal information to develop advertising campaigns to induce or solicit individuals to purchase selected goods and services.

On a more personal level, friends are able to refer products and services to their friends by sending links through communication applications. This type of referral marketing may be effective at persuading friends to purchase goods and services in a convenient way that turns visitors into brand supporters.

What is needed is a referral marketing mechanism that may be universally applied to any on-line or offline environment that maintains private communications between referring friends while gathering metrics information that may be viewed by brand owners to determine whether a marketing campaign is cost-effective.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A system and method are provided for enabling an endorser to disseminate referrals to selected contacts within a familiar, trusted environment that includes making a selection to promote at an owner website and selecting a link at the owner website to enter the trusted environment. The endorser selects at least one contact and parameters at the trusted environment. The trusted environment generates or provides incentive data based on the selected parameters and displays the incentive data at webpage associated with a selected Uniform Resource Locator. Within the trusted environment, a messaging application is selected to generate a personal message to the selected at least one contact and provides the Uniform Resource Locator within the personal message to direct a browser associated with the at least one contact to enter the trusted environment. The endorser and the contacts may redeem incentives on the owner's site or within the trusted environment. Following redemption, the endorser and the contacts may be returned to a redirecting website.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a communication system for a promotional platform according to one example;

FIG. 2 is a communication system for a promotional platform according to one example;

FIG. 3 is a screen shot illustrating a personal promotion webpage associated with an endorser according to one example; and

FIG. 4 is a flow chart illustrating a process of creating a referral campaign over social media according to one example.

FIG. 5 illustrates a screen shot of registration in accordance with an exemplary embodiment.

FIG. 6 illustrates a screen shot of registration confirmation in accordance with an exemplary embodiment.

FIG. 7 illustrates a screen shot of an owner landing page in accordance with an exemplary embodiment.

FIG. 8 illustrates a screen shot of an owner offer page in accordance with an exemplary embodiment.

FIG. 9 illustrates a screen shot of an owner offer screen for messaging in accordance with an exemplary embodiment.

FIG. 10 illustrates a screen shot of contacts choice screen associated with contacts for an endorser in accordance with an exemplary embodiment.

FIG. 11 illustrates a screen shot of an email messaging screen in accordance with an exemplary embodiment.

FIG. 12 illustrates a screen shot of a coupon offer screen in accordance with an exemplary embodiment.

FIG. 13 illustrates a screen shot of an email summary screen associated with a confirmation message in accordance with an exemplary embodiment.

FIG. 14 illustrates a screen shot of email confirmation message in accordance with an exemplary embodiment.

FIG. 15 illustrates a screen shot of an endorser page depicting active offers to others in accordance with an exemplary embodiment.

FIG. 16 illustrates a screen shot of additional content of an endorser page in accordance with an exemplary embodiment.

FIG. 17 illustrates a screen shot of an endorser offer presented to a visitor in accordance with an exemplary embodiment.

FIG. 18 illustrates a screen shot of a merchant page including a promotional icon included in a list of items in accordance with an exemplary embodiment.

FIG. 19 illustrates a screen shot of a merchant page involving a selected item including a promotional icon in accordance with an exemplary embodiment.

FIG. 20 illustrates a screen shot of a merchant offer page in accordance with an exemplary embodiment.

FIG. 21 illustrates a screen shot of a messaging screen for use by an endorser in accordance with an exemplary embodiment.

FIG. 22 illustrates a screen shot of an email message list screen containing a confirmation message in accordance with an exemplary embodiment.

FIG. 23 illustrates a screen shot of an email confirmation message to an endorser in accordance with an exemplary embodiment.

FIG. 24 illustrates a screen shot of an endorser page including active offers in accordance with an exemplary embodiment.

FIG. 25 illustrates a screen shot of an endorser page with curated content in accordance with an exemplary embodiment.

FIG. 26 illustrates a screen shot of a selected offer from an endorser page in accordance with an exemplary embodiment.

FIG. 27 illustrates a screen shot of active endorsement content in accordance with an exemplary embodiment.

### DETAILED DESCRIPTION

This disclosure describes systems, non-transitory computer-readable media, and methods of using promotional platforms to promote marketing campaigns within trusted environments that include on-line and off-line components. Throughout this disclosure, trusted environments include environments that are familiar to users and that allow users to exchange communications within private sessions. The promotional platforms allow users to reach significant numbers of contacts directly, indirectly and interactively. In one example, the method includes accessing the promotional platforms using a referral application that allows visitors or users to self-select a brand to promote for a defined amount of time within the trusted environments. The referral application links brand owners or third party promoters (“owners”) to visitors, loyal customers, users and brand endorsers (“endorsers”). The referral application further links endorsers to endorser's friends and acquaintances (“contacts”) and brand consumers (“consumers”). The referral application also links endorsers to a contact's nth degree friends and acquaintances (“contacts”). The referral application enables endorsers to promote a selected brand for a defined amount of time within the trusted environments. As a result, the promotional platform supports organic, viral, targeted and highly-charged word-of-mouth referral campaigns.

The referral application allows endorsers to perform functions, such as create a profile; select a brand; select an endorsement time period; browse offers and promotions provided by owners; select an offer or promotion for the endorser; generate a private referral message; select a communications preference; select incentives to be offered to contacts; and select contacts that are designated to receive the private referral message; among other functions.

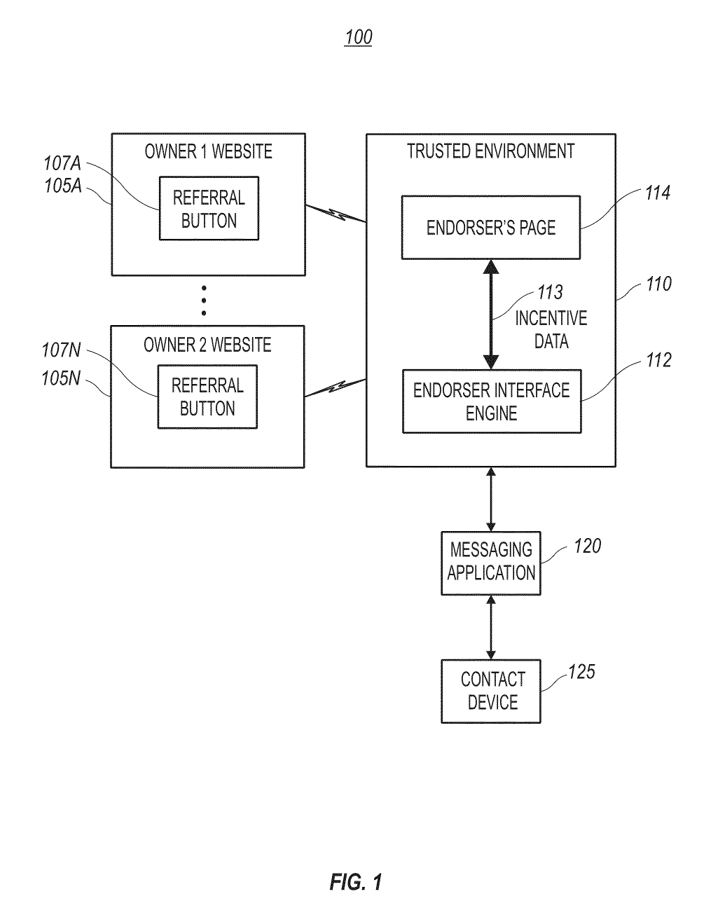

FIG. 1 illustrates an exemplary promotional platform 100 that includes a plurality of owner websites 105a-105n, a trusted environment 110, a messaging application 120, and one or more contact devices 125. According to one example, the trusted environment 110 provides users of the promotional platform 100 with a consistent look and feel and a secure gateway for navigating various on-line resources. The trusted environment 110 may include a plurality of components for communicatively coupling the plurality of owner websites 105a-105n and the one or more contact devices 125. For example, the trusted environment 110 may include an endorser interface engine 112 and an endorser's page 114, among other components.

The user devices may include or access a referral application for accessing resources through the trusted environment 110. The referral application may provide a consistent graphical user interface (“GUI”) for navigating various resources, including the plurality of owner websites 105a-105n, the endorser interface engine 112, and an endorser's page 114, among other resources.

The owner websites 105a-105n may include an icon, such as a corresponding referral button 107a-107n, that is positioned on a webpage for selection by users visiting the webpage. The referral button 107a-107n may be provided at a selected location on the owner webpage. For example, the referral button 107a-107n may be prominently positioned in an upper left corner of the owner webpage. One of ordinary skill in the art will readily appreciate that the referral button 107a-107n may be positioned at any desired location within a webpage. Upon selection, the referral button 107a-107n may be configured to redirect a browser application associated with the user device from the owner website 105a-105n to the trusted environment 110. Alternatively, the referral button 107a-107n may be configured to perform some other action.

For example, a member of a recreational sports team may be a loyal customer of a particular brand owner and may desire to influence his or her teammates to purchase a same brand of soccer shoes. In this regard, the member or user may navigate a web browser to a Uniform Resource Locator (“URL”) associated with the brand owner website in order to browse among one or more soccer shoes displayed on-line. If the brand owner subscribes to the referral service associated with the trusted environment, then the user may be presented with a corresponding referral button 107 on one or more webpages while visiting the brand owner's website 105. Upon selecting the corresponding referral button 107, the browser application associated with the user device is re-directed from the owner's website 105 to the trusted environment 110. In this regard, the referral button 107 provides a convenient way of communicating with contacts through the trusted environment 110. Upon completing actions within the trusted environment 110, the browser application may be returned to a same website that initiated the redirect.

As an alternative to using the referral button 107 to enter the trusted environment 110, the referral application allows visitors to directly access the trusted environment 110 via a dedicated URL. Once within the trusted environment 110, the endorser interface engine 112 may allow users to search through a list of owners or items for brands and incentives that are registered with the trusted environment 110.

As described in further detail below, if the user is registered with a referral server that is associated with the trusted environment 110, the user may be authenticated by matching authentication information with access information that preexists on the referral server. Alternatively, if the user is not authenticated by the referral server, then the user may be invited to submit requested authentication information or take other action.

If the user is authenticated, then the user may be directed to the endorser interface engine 112, which enables the user to access an endorser set-up page. As described in further detail herein, the endorser set-up page allows endorsers to select contacts, select a messaging application, select an exclusive endorsement period, select desired endorser incentives, and select incentives to be offered to the selected contacts, among performing other actions. The endorser interface engine 112 presents endorsers with content that may be customized according to individual brand owners, while providing endorsers with a functionality and a look and feel that remains uniform within the trusted environment 110. In other words, the functionality of the endorser interface engine 112 remains familiar to endorsers within the trusted environment 110, regardless of the brand owner website 105a-105n that directed the endorser to the trusted environment 110. This aspect of the disclosure allows the trusted environment 110 to preserve a desired functionality and a look and feel, while enabling owners to control brand messages and identify a source of the goods and services within the trusted environment 110. The brand owner's landing webpage within the trusted environment 110 may be designed to provide a brand owner's graphic appearance and may promote the brand owner's marketing programs and corporate standards. Alternatively, the trusted environment 110 may be extended into the brand owner's website 105a-105n and supported by the brand owner's website resources.

The referral application allows endorsers to communicate with one or more contacts using any of several messaging applications. For example, endorsers may select to communicate with contacts through an email application, an instant messaging application, telephony, hardcopy mail, or a social media application, among other messaging communications and applications. According to one example, the endorser may access the endorser interface engine 112 to generate a message that is sent to the contact using selected messaging application, such as FACEBOOK™. The message includes a URL that directs the contact to an endorser's page when selected.

The referral application allows endorsers to create and send personal messages to contacts in order to personally suggest a product, service, or other items that the endorser believes will be of interest to a contact. According to one example, endorsers may select contacts from a list of connections, such as friends, acquaintances, and social media contacts, or the like. The referral application further presents a contact's friends and acquaintances to the endorser, which broadens the number of potential consumers that are available to the endorser.

The referral application enables owners to propose offers and promotions to endorsers in order to motivate the endorsers to select the brand owner, brand owner services or brand owner products over other brand owners or brand owner services and products. The offers and promotions may include discounts, gift cards, coupons, loyalty points, or the like. The referral application may further provide tools and applications that enable endorsers to both generate and send custom referrals to selected contacts. The referral application automatically may generate an endorser's personal webpage URL (“URL”) for display using the referral message sent to contacts. The URL allows contacts to easily locate and redeem incentives that the endorser selects for the contacts. The contact or the contact's acquaintances may access the URL, even if these contacts are not registered through the referral application. In other words, users may access URLs that are received indirectly from the trusted environment 110. In this way, a contact's acquaintances may access the endorser's personal webpage and redeem incentives offered therein.

The referral application enables contacts to receive the custom referrals, follow the URL in order to review offers provided on the endorser's personal webpage, redeem incentives offered directly or indirectly to the contacts, and redeem, purchase, or otherwise take action regarding the referred item. The referral application also enables unwinding of the custom referral. The referral application may communicate with contacts through social media applications, including FACEBOOK™, TWITTER™, YOUTUBE™, SECOND LIFE®, LINKEDIN®, Google+™, or the like. While specific examples discussed herein are directed to social media applications, the systems and methods described herein can be applied to any type of interaction or communication for any purpose using any type of communication platform or communication environment, including on-line and off-line environments.

The promotional platform 100 provides a user-centric or trusted environment 110 that allows endorsers to promote a selected brand owner, service or product; select an incentive offered by the brand owner; generate personal messages for delivery to contacts, where the personal messages are sent with or without brand owner generated content; choose the media channels to deliver the custom referrals; identify contacts to receive the custom referral; select an exclusive time period for promoting the brand owner, the service and the product; select incentives to offer to contacts; and provide a mechanism for any recipient to access an incentive through the endorser's personal webpage. The promotional platform 100 allows endorsers and contacts to redeem the incentives. For example, the promotional platform 100 allows endorsers to redeem incentives by re-directing the endorsers from the owner's website 105 to the trusted environment 110. Upon completing the redemption process, the promotional platform 100 returns endorsers to the owner's website 105 or another selected website. According to another example, the promotional platform 100 allows contacts to redeem incentives by re-directing the contacts from the endorser's page 114 within the trusted environment 110 to an owner's website 105 associated with the incentives. Upon completing the redemption process, the promotional platform 100 returns contacts to the endorser's page 114 or another selected website. Additionally, for unregistered contacts, the promotional platform 100 may present a registration module 347 to the contacts as described herein.

The promotional platform 100 allows loyal consumers and endorser contacts to become brand referral agents or marketers. Through the trusted environment 110, the referral application allows endorsers to create personal and private messages that may be sent to contacts. The trusted environment 110 may track the endorser's promotions across several websites and may aggregate data associated with the several websites. An endorser's page allows contacts to redeem incentives through a personal webpage that uniquely represents the endorser. The contacts may likewise become endorsers themselves by accessing the trusted environment 110.

The promotional platform 100 provides brand owners with analytics data to evaluate referral campaigns. The analytics data may include data such as landing page hits (“clicks”) data, referral application hits (“premium clicks”) data, contact clicks data, demographic data, accepted and redeemed offers and incentives data, deal power data, category leader data, and custom-sourced messaging data, among other analytics data. The promotional platform 100 is configured to operate across various communities including mobile communities, physical communities, and virtual communities. The promotional platform 100 may process the analytics data within the trusted environment 110 and may provide performance data to brand owners or third parties. Alternatively, the promotional platform 100 may provide the analytics data to a source that is external to the trusted environment 110 for processing outside the trusted environment 110.

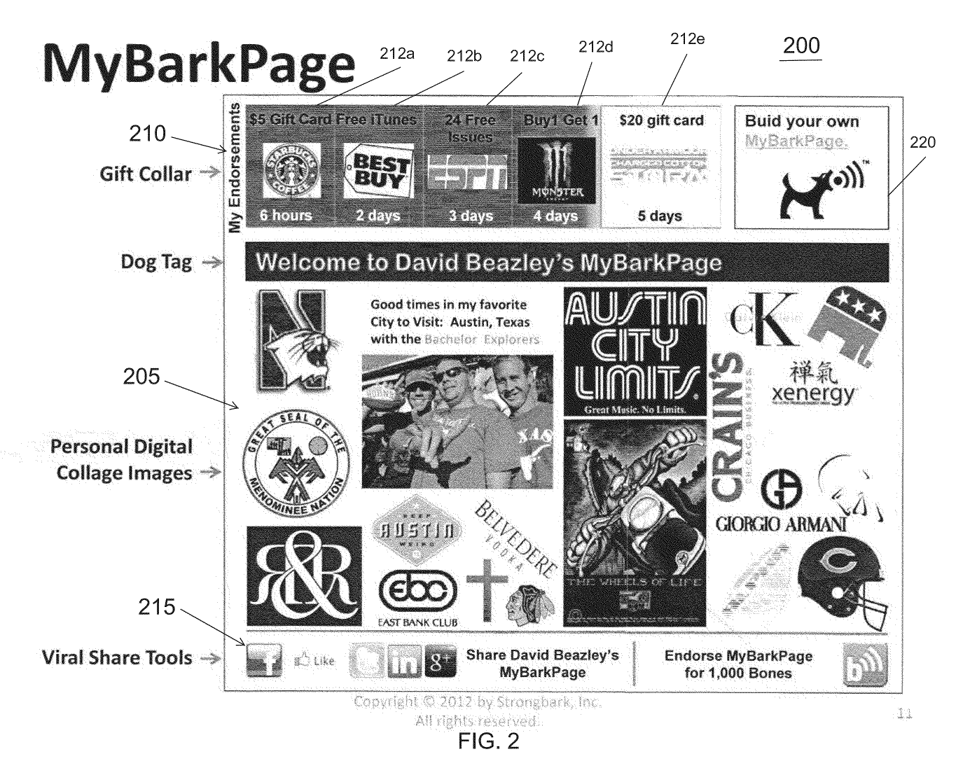

FIG. 2 illustrates an exemplary the endorser's page 200 that includes a content section 205, a banner section 210, and a share section 215. The content section 205 reflects the endorser's personality and may provide a snapshot in time of the endorser's preferences, including an endorser's likes and dislikes. The content section 205 may also be created by the user from selected content. For example, the content section 205 may be created using artwork, photographs, music, videos, articles, blogs content, or the like. According to one embodiment, the content section 205 may be limited to a prescribed length, such as a single page. The content displayed within the content section 205 will be generally familiar to the endorser's contacts that visit the endorser's page 200 and may serve to confirm the authenticity of the endorser to the contact. The familiar aspects of the content displayed within the content section 205 will further place contacts at ease and remove any hard product sell aspect of the referral. In this way, contacts will feel comfortable requesting additional information from a trusted endorser or the promoted brand to genuinely decide whether a product or service will be a good fit for the contact.

The endorser's page 200 may include a banner section 210 positioned along a selected portion of the endorser's page 200. For example, the banner section 210 may be provided along a perimeter of the endorser's page 200, such as an upper portion of the endorser's page 200. The banner section 210 may include a snapshot of any active endorsements associated with the endorser. For example, the banner section 210 may display active endorsements spanning a time period, such as a 5-day period. As illustrated in FIG. 2, the banner section 210 further illustrates brand logo prominence in each of active endorsements 212a-212e. Active endorsements 212a-212e are shown to be of general consistency, for example, similar geometric shape, size, logo positioning, and offer (collectively, normalized) to conform to the banner region 210 constraints. Although banner region 210 depicts active endorsements 212a-212e each of generally consistency, it would be understood to a person of skill in the art that other shapes, sizes and relative prominence may be provided for any of active endorsements 212a-212e. During a pendency period, a remaining amount of time may be displayed with each active endorsements 212a-212e. When expired, the active endorsements 212a-212e provided in the banner section 210 may disappear. If no active endorsements are presented in the banner section 210, then the banner section 210 may be populated with other messages. Alternatively, the banner section 210 may be eliminated and the content area of 205 may be expanded into the region previously occupied by the banner section 210.

The banner section 210 of the endorser's page 200 may be published on-line and may be controlled to display pending or active endorsement content 212a-212e. The endorser interface engine 112 may automatically populate active endorsement content 212a-212e in the banner section 210 via a link 113 when the endorser sends the private referral messages to contacts using the messaging application 120. The contacts may be presented with the endorser's page 200 and specific incentives provided in the banner section 210 upon clicking the URL included in their personal referral message received from the endorser.

Contacts that follow the URL to the endorser's page 200 may redeem the selected incentive. Alternatively, the contact may redeem any other active incentive that is provided in the banner section 210 of the endorser's page 200. Further, any visitors to the endorser's page 200, such as contacts of contacts, also may redeem one or more incentives that are presented in the banner section 210 or may choose to become endorsers of products or services promoted through trusted environment 110.

In an alternative embodiment, the endorser may embed live or active links in the content section 205 to re-direct a browser on a contact's device to an external website. The external website may present advertisements. Similar to active endorsements, any active links provided in the content section 205 may disappear when expired. If applicable, a remaining amount of time may be displayed in the content section 205 for each active link.

In further alternative embodiments, the content section 205 may be eliminated entirely from the endorser's page 200 and may be replaced by an enlarged banner section 210. The banner section 210 may include additional content, such as an invitation for a contact to endorse a product or brand in the future. According to a further example, the endorser and the entity controlling the trusted environment 110 may enter into a revenue sharing arrangement for displaying content on the banner section 210 or the content section 205.

The endorser's page 200 provides, in a limited amount of space, a one-stop look at what the endorser values based on self selected content displayed therein. The endorser's page 200 is addressable by a unique URL that may be shared or linked by the endorser or the endorser's contacts for display on existing social media sites or other communication applications. According to one example, the content section 205 of the endorser's page 200 will remain unchanged until modified by the user. According to one example, the content on the endorser's page 200 may be searched or rendered searchable in whole or in part by search engines.

The endorser's page 200 may further include a share section 215 that allows contacts visiting the endorser's page 200 to share their visit with other contacts, “Like” the endorser's page 200, or directly endorse the endorser's page 200 for a selected incentive, such as “1,000 Bones.” The endorser's page 200 further may include a new user icon 220 that directs an unregistered contact to a new user registration webpage whereby the unregistered contact may choose to become an endorser of products or services promoted through trusted environment 110.

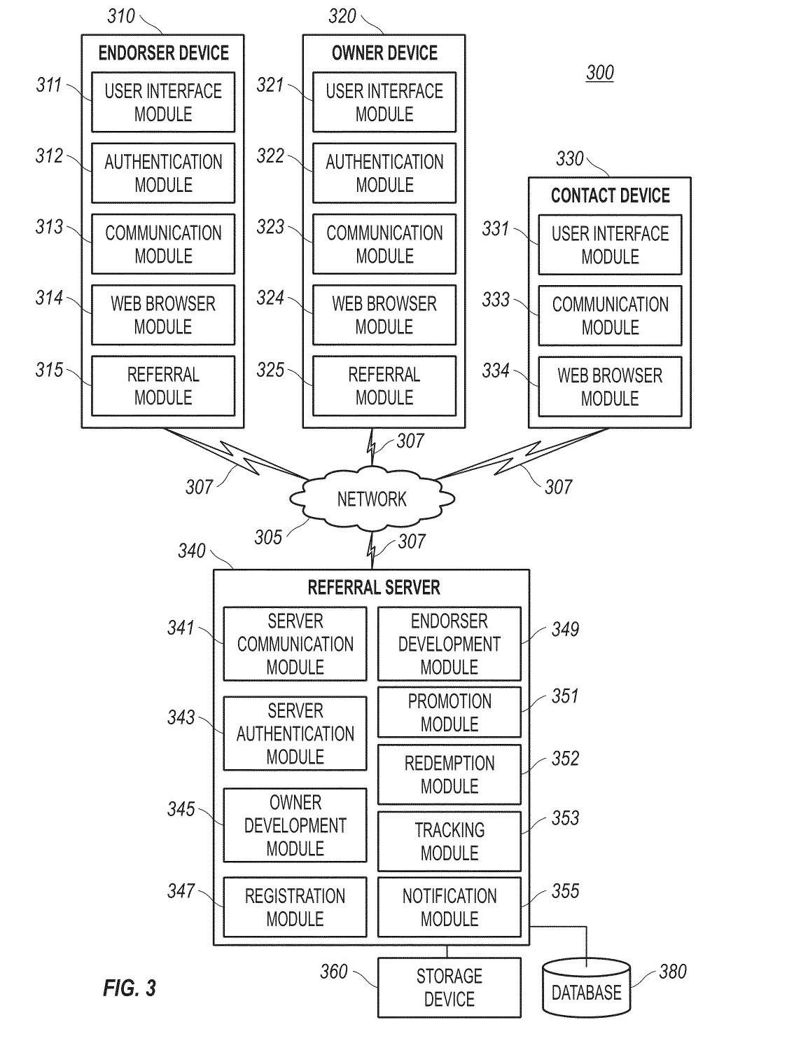

FIG. 3 illustrates system architecture 300 according to one example. The endorser device 310, the owner device 320, the contact device 330, and one or more referral servers 340 may be coupled via communication media 307, such as wired media, wireless media, paper media, or a combination thereof. Communication media 307 serves as a secure gateway through network 305 to communicate with the referral sever 340 in in trusted environment 110. According to one example, the endorser device 310, the owner device 320, the contact device 330 and the referral server 340 may reside in one or more networks, such as an Internet, an intranet, a cellular network, or a combination thereof. Any data communicated between the endorser device 310, the owner device 320, the contact device 330 and the referral server 340 may include unique identifiers that associate the communication data with the corresponding devices, as well as an endorser, an owner, and/or a contact.

According to one example, the endorser device 310, the owner device 320, and the contact device 330 may include any number of different types of devices for performing communications, sharing electronic files and recording electronic content, such as video, pictures, audio, and text. The devices may include smart phones, tablets, personal computers, laptops, personal digital assistants (PDAs), cell phones, portable processing devices that combine the functionality of one or more of the foregoing, and/or other devices. The endorser device 310, the owner device 320, the contact device 330 may include imaging devices for reading markers, such as Quick Response (QR) codes or the like. For example, the imaging devices may include optical scanners, radio frequency scanners or the like.

The endorser device 310, the owner device 320, and the contact device 330 may include several components, including a processor, a random access memory (RAM), a universal serial bus (USB) interface, a scanner, a telephone interface, a microphone, a speaker, a stylus, a computer mouse, a wide area network interface, a local area network interface, a hard disk drive, a wireless communication interface, a keyboard, a touch-screen display, a computer display, and/or other components. The endorser device 310, the owner device 320, and the contact device 330 may include, or be modified to include, software that operates to gather and exchange data. The devices 310, 320, and 330 may be provided with an operation system that controls various applications and software modules.

The referral server 340 may reside in or outside of the trusted environment 110, although remain in communicative contact with trusted environment 110, and may include several components, including processors, random access memory (RAM), universal serial bus (USB) interfaces, telephone interfaces, microphones, speakers, a wide area network interface, local area network interfaces, hard disk drives, wireless communication interfaces, user interfaces, and other components.

Additionally, the endorser device 310, the owner device 320, the contact device 330 and the referral server 340 may include several modules. The modular construction facilitates adding, deleting, updating and/or amending modules therein and/or features within modules. One skilled in the art will readily appreciate that the invention may be implemented using individual modules, a single module that incorporates the features of two or more separately described modules, individual software programs, and/or a single software program.

The endorser device 310 may include, or be modified to include, various modules, including a user interface module 311, an authentication module 312, a communications module 313, a web browser module 314, a referral application or module 315, and/or other modules. It should be readily understood that a greater number or lesser number of modules may be used.

The owner device 320 may include, or be modified to include, various modules, including a user interface module 321, an authentication module 322, a communications module 323, a web browser module 324, a referral application or module 325, and/or other modules. It should be readily understood that a greater number or lesser number of modules may be used.

The contact device 330 may include, or be modified to include, various modules, including a user interface module 331, a communications module 333, a web browser module 334, and/or other modules. It should be readily understood that a greater number or lesser number of modules may be used.

According to one example, the endorser device 310, the owner device 320, and the contact device 330 may communicate with other devices through corresponding communication modules 313, 323 and 333. Furthermore, the corresponding user interface modules 311, 321, 331 may support several interfaces, including display screens, voice recognition systems, speakers, microphones, input buttons, and/or other interfaces. The user interface modules 311, 321, 331 may display the browser application or module 314, 324, 334 on a display screen (not shown) associated with the corresponding devices 310, 320, 330. Users may interact with device display screens to implement desired functions. For example, users may position an indicator over selected icons on the display screen by manipulating an input receiving device, such as a mouse, a keyboard, or other input receiving device. Alternatively, users may implement functions on devices using a voice recognition system that enables hands-free operation.

With regard to user authentication, the authentication modules 312, 322, may employ one of several different authentication schemes, as would be appreciated by those skilled in the art. The authentication modules may prompt users to input alphanumeric code or other identifying information. Alternatively, the authentication modules 312, 322, may prompt users to provide biometric information (i.e., a thumbprint through a fingerprint scanner) or other suitable identifying information. If the user is not known to the system, then the system may invite the user to submit requested identification information or to take other action to become registered.

The endorser device 310, the owner device 320, and the contact device 330 may include communication modules 313, 323, 333 that enable the devices to communicate with other devices using communications media 307. For example, the devices 310, 320, and 330 may communicate using one or more of the following wireless network types: LTE (Long Term Evolution); Mobitex Radio Network; DataTAC; GSM (Global System for Mobile Communication); GPRS (General Packet Radio System); TDMA (Time Division Multiple Access); CDMA (Code Division Multiple Access); CDPD (Cellular Digital Packet Data); iDEN (integrated Digital Enhanced Network); Ev-DO (Evolution-Data Optimized); CDMA2000; EDGE (Enhanced Data rates for GSM Evolution); UMTS (Universal Mobile Telecommunication Systems); HSPDA (High-Speed Downlink Packet Access); IEEE 802.16e (also referred to as Worldwide Interoperability for Microwave Access or “WiMAX”), or various other networks. The communications media 307 may include wired and wireless media that supports substantially real-time communications when the devices are connected to the network 305. The communications media 307 may also include paper, telephony or broadcast delivery that supports communications between the endorser and a contact as supported by the network 305.

The referral server 340 may include, or be modified to include, various modules, including a server communications module 341, a server authentication module 343, an owner development module 345, a registration module 347, an endorser development module 349, a promotion module 351, a tracking module 353, a notification module 355, a redemption module 357, and/or other modules. The server 340 may be implemented using the World Wide Web (“WWW”) and may be configured to form the trusted environment 110. It should be readily understood that the invention may be implemented with a greater number or lesser number of modules.

The server communications module 341 operates to provide data gathering and data exchange functionality. For example, the server communications module 341 communicates with the endorser device 310, the owner device 320, and the contact device 330 to initiate data transmission and data reception and supports communications between these devices.

The server authentication module 343 receives authentication information entered into the authorization modules 312, 322, of the corresponding endorser device 310 and the owner device 320. The server authentication module 343 compares the authentication information received from the devices 310, 320 with pre-existing records and operates as a gatekeeper to the system 300. If a determination is made that the user is a registered user, the server authentication module 343 attempts to authenticate the registered user by matching the entered authentication information with access information that preexists on the referral server 340. If the user is not authenticated, then the user may be invited to submit requested authentication information or take other action.

After a user is authenticated, the referral server 340 may perform other processing. For example, the devices 310, 320 associated with the authenticated user are permitted to log into the referral server 340, submit information requests, and receive information, among performing other actions. If a user is not authenticated, then the server authentication module 343 may provide the user with a registration user interface prompting the user to register. Requested registration information may include, for example, user names, corporate names, addresses, identification numbers, telephone numbers, and other registration information. After receiving the registration information and performing a verification process, the server authentication module 343 may add the user to the list of authorized users.

The referral server 340 includes a storage device 360 that stores content and data. The content and data may be associated with a web address or a URL that provides a global address for locating the content and data on the WWW). A web browser associated with one of the endorser device 310, the owner device 320, and the contact device 330 receives the URL and downloads a web page associated with the web address. The web page includes informational content that is accessible to the general public and is relevant to referral campaigns, among other topics. The public portion of the web page may include a home page having various tabs, including an About Us tab, a News tab, a Contact Us tab, a Customer Service tab, a Privacy tab, a How This Program Works tab, a User Dashboard tab, an Endorser Page tab, a Search for Advertiser's tab, a Keyword Search tab, a Search for Celebrities tab and a Blog tab, among other tabs. The web page may also include a member's only portion that is accessible to new users through a “Registration” tab and to returning users through a “Sign In” tab.

If the owner is a new user, then the registration module 347 may present the owner with a form to complete upon selection of the registration tab. The form may prompt users for information, including a name, contact information, demographic criteria, social media preference, accounting data, type of referrals, types of incentives, incentive values, referral budget, data storage requirements, metric requests, among other information.

The registered user portion of the web page is configured to include an owner-centric section and an endorser-centric section. Registered users may access the registered user portion using a corresponding endorser device 310 or the owner device 320. The owners and endorsers access a corresponding web browser module 314, 324 and enter a URL that directs the corresponding devices 310, 320, 330 to a secure web page provided on the referral server 340.

The referral server 340 may include an owner development module 345 that interfaces with the owner referral module 325 provided on the owner device 320. The owner development module 345 enables the owner to create or maintain the owner-centric section of the web page, including a brand owner's page. The brand owner's page may include various tabs, such as a Wizards tab, a Policies tab, an Advertiser Dashboard tab, a Reporting on Transactions tab, an Analytics tab, a Getting Started tab, and a License Agreement tab, among other tabs. The owner-centric section may be created using customized templates that reflect the look and feel of the brand owner's web presence.

If the brand owner is an unregistered user, then the registration module 347 presents the owner with a registration form for completion through the web browser module 324. The form may prompt owners for information, including a company name, contact information, demographic criteria, accounting data, type of referrals, types of incentives, incentive values, referral budget, data storage requirements, and metric requests, among other information.

The owner development module 345 enables owners to generate a brand owner's landing webpage that includes an offer area and an owner messaging content area that is viewable by potential endorsers, among other areas. The offer area presents at least one gift or other incentive that is available for endorser selection for himself or herself, including a minimum amount of loyalty points for promoting a selected product. The offer area also may present at least one gift or other incentive that is available for endorser selection, which will be offered to the endorser's contact following redemption by the endorser of a gift or other incentive.

The owner development module 345 re-directs the web browser module 314 to the messaging application 120 to enable an endorser to generate a private message for the selected contacts. The private message presents the promotion directly from the endorser in a way that may entice the contacts to redeem the displayed product or service. The brand owner's landing webpage associated with the trusted environment 110 may include editing tools, such as pop-up media selection icons and text entry tools, to facilitate data entry.

Once the brand owner has completed entering items and incentives associated with the landing webpage, the owner may upload the content to a database 380 that is available for search by potential visitors. The potential visitors may perform the search using a variety of techniques. For example, the search may be perform the search using a structured query language (SQL) using SQL statements to perform tasks on the database 380, such as retrieving data. The data retrieved from the database 380 may be restricted depending on parameters associated with the endorser. For example, unknown endorsers may be offered fewer incentives compared to known and highly desired endorser.

The referral server 340 within the trusted environment 110 may include an endorser development module 349 that interfaces with the endorser referral module 315 on the endorser device 310. The endorser development module 349 may include the endorser interface engine 112 that enables endorsers to create or maintain the endorser-centric section of the web page, including an endorser set-up page and an endorser's page 200.

A promotion module 351 within the trusted environment 110 is configured to disseminate the endorser's private message to contacts as defined by the endorser. According to one example, the promotion module 315 interfaces with the messaging application 120 to disseminate the private message having a URL to the endorser's page 200, which provides a snapshot in time of the endorser's preferences, including an endorser's likes and dislikes. The content displayed through the endorser's page 200 may be obtained from various sources that are both internal and external to the referral server 340, which resides within the trusted environment 110. The endorser development module 349 is configured to provide tools needed by the endorser to create and modify the endorser's page 200. As discussed above, the endorser's page 200 further may include an share section 215 that allows visitors to the endorser's page 200 to easily share their visit and Like the endorser's page 200 to their contacts, or to directly endorse brand owners featured in the banner section 210. The endorser's page 200 may include a new user icon 220 that directs an unregistered contact to a new user registration webpage.

As discussed above, the banner section 210 is published on the WWW and may be controlled by the referral server 340 to display current endorsement content or active endorsements 212a-212e. If there are no active endorsements presented in the banner section, then the referral server 340 may populate the banner section 210 with other messages or expand the content area of 205 and eliminate the banner section 210 entirely. According to one example, the endorser and the entity controlling the referral server 340 may enter into a revenue sharing arrangement for displaying content on the banner section 210 or the content section 205.

The endorser development module 349 may present various tabs to an endorser, such as a Select Incentive tab, a Select Communication Type tab, a Select Contacts tab, a Create Referral tab, a Getting Started tab, a License Agreement tab, and a Preferences tab, among other tabs. The endorser development module 349 also may provide an unwind button on the endorser's page 200 that enables the endorser to terminate displaying the endorsement after a minimum amount of display time, such as 1 day. The unwind button may include other functionality. For example, the unwind button may include functionality to capture reasons that led to the disapproval of the endorsement.

An endorser development module 349 may further enable an endorser to manage the endorser's page 200 using a corresponding endorser device 310. From the home page, the endorser is presented with a “Registration” tab for new users and the “Sign In” tab for returning users. If registration is needed, the endorser is prompted to submit a name, contact information, demographic criteria, and preferred incentives, among other information.

The endorser development module 349 further allows endorsers to select contacts from any combination of sources, including social networking sites, email addresses, text messages, and contact lists, or the like. After selecting desired contacts, the endorser interface engine 112 communicates with a messaging application 120 to disseminate the private promotions. The endorser interface engine 112 further communicates with the endorser's page 200 to provide the exclusive endorsement period, the endorser incentives, and the incentives to be offered to the selected contacts. The endorser gifts and incentives may expire after a predetermined amount of time. Similarly, the incentives offered to selected contacts may expire after a predetermined amount of time.

According to one example, the endorser interface engine 112 may dynamically determine the value of endorser gifts and incentives offered to the endorser. The value of endorser gifts and incentives offered to the endorser may vary depending on criteria associated with the endorser. For example, the value of the gifts and incentives may be determined based on pre-selected criteria, including a length of time the endorser agrees to exclusively market the product or owner, a number of contacts the endorser selects to market to, social networks the user selects to market through, a celebrity status, prior marketing effectiveness, personal demographics, and usage history, among other pre-selected criteria. Additionally, the endorser interface engine 112 may offer more valuable gifts and incentives to known and desired endorsers as compared to unknown endorsers. Alternatively, the endorser interface engine 112 may determine a value of the gifts and incentives in real-time based on a bidding process. The endorser interface engine 112 may restrict the endorser to endorsing one product or owner at a time or within a specified time period, such as 24-hours. The endorser interface engine 112 may require the endorser to select at least one contact and to offer at least one gift for the contact. The endorser interface engine 112 may further be configured to withdraw from selection further endorsement offers or gifts beyond a determined threshold.

Following selection of the item or owner, and after determining the exclusive endorsement period and after selection of gifts and incentives, the endorser may access the messaging application 120 to create and distribute a personal referral message to the list of selected contacts. The personal referral message is a private message sent from the endorser to the contact, which is not viewable to the owner. Once the endorsement is complete, the endorser is presented with an icon or identifier to electronically (or otherwise) propagate the endorsement to the selected contacts. The endorser's page 200 displays the endorsement particulars of the incentives chosen for the contacts on the banner section 210 as described above. The endorser's personal message may not appear anywhere on the endorser's page 200.

The contacts receive the endorsement as a private message through various mediums originating from the endorser, who is a known contact. For example, the private message may be directly sent from a messaging application 120 controlled by the endorser to the contact. The private message may include a URL in the message body that directs the contact's browser to the endorser's page 200. The private message may include software code that captures actions performed by the contact upon opening the private message. The server communication module 341 may capture the data associated with the actions performed by the contacts as analytics data that is shared with the owner.

The trusted environment 110 may further provide a user interface that allows a brand owner or a third party to obtain software code for adding a referral button 107 to their websites. Alternatively, the referral button 107 may be associated with a counter card or printed flyer or other printed or electronic display with a QR code, for example. The referral button 107 is configured to re-direct a browser to the referral server 340 from any website or electronically readable symbol.

The referral server 340 may further include a redemption module 352 that allows endorsers and contacts to redeem the incentives. For example, the redemption module 352 allows endorsers to redeem incentives by re-directing the endorsers from the owner's website 105 to the trusted environment 110 to. Upon completing the redemption process, the redemption module 352 may return endorsers to the owner's website 105 or another selected website. According to another example, the redemption module 352 allows contacts to redeem incentives by re-directing the contacts from the endorser's page 114 within the trusted environment 110 to an owner's website 105 associated with the incentives. Upon completing the redemption process, the redemption module 352 returns contacts to the endorser's page 114 or another selected website. Additionally, for unregistered contacts, the registration module 347 may be presented to allow contacts to register with the referral server 340.

The referral server 340 may further include a tracking module 353 that enables tracking of data communication across a network. For example, the tracking module 353 may associate an internet protocol (IP) address, or other identifying information, of the endorser device 310, the owner device 320, and the contact device 330 with data that is exchanged with the trusted environment 110. The data tracking features may be employed to generate usage logs that may be used to calculate metrics. The tracking module 353 may remotely activate and remotely deactivate software agents provided in the devices 310, 320, 330, based on payment of a fee, such as a subscription fee.

The tracking module 353 may include monitoring features that monitors communication between the trusted environment 110 and the endorser device 310, the owner device 320, and the contact device 330. The tracking module 353 may monitor data packets that traverse communications lines 307, wherein the data packets may include identification markers. The extracted information may include data requests that correspond to selected entities that are associated with the trusted environment 110.

The referral server 340 may include a notification module 355 that generates notifications and/or alerts. The notification module 355 may generate and forward notifications to, the endorser device 310 or the owner device 320 upon receipt of requested information by the referral server 340.

FIGS. 1-3 are provided for illustrative purposes only and should not be considered limitations of the invention. Other configurations will be appreciated by those skilled in the art and are intended to be encompassed by the invention.

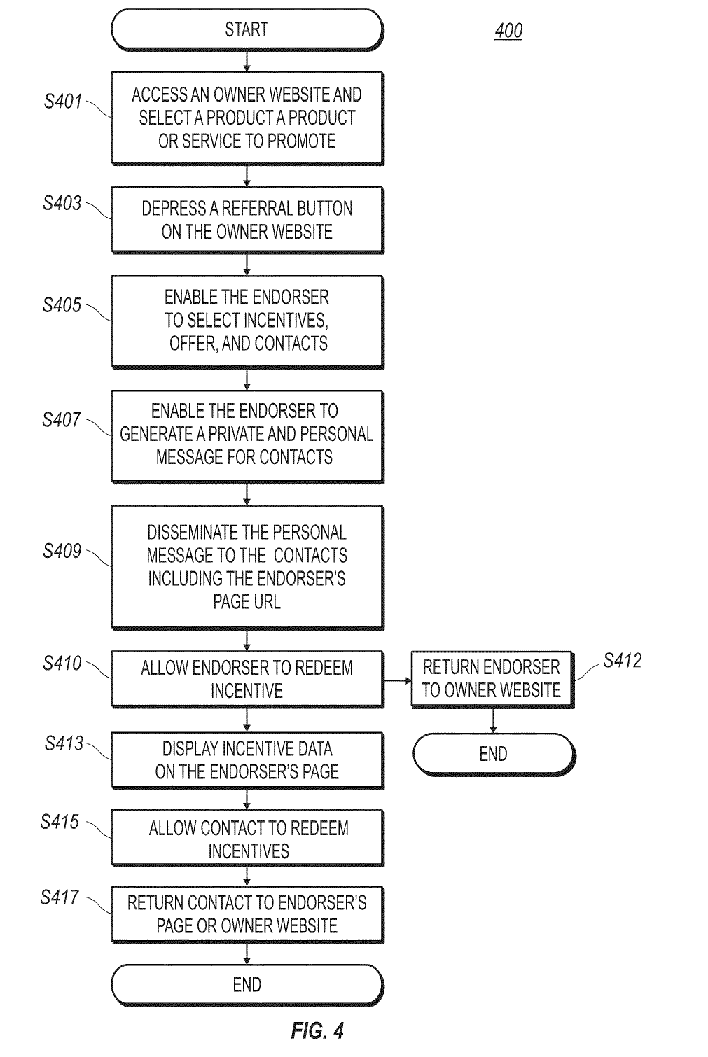

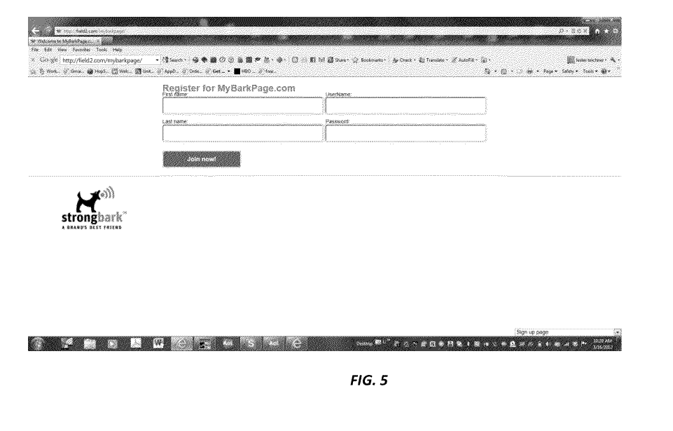

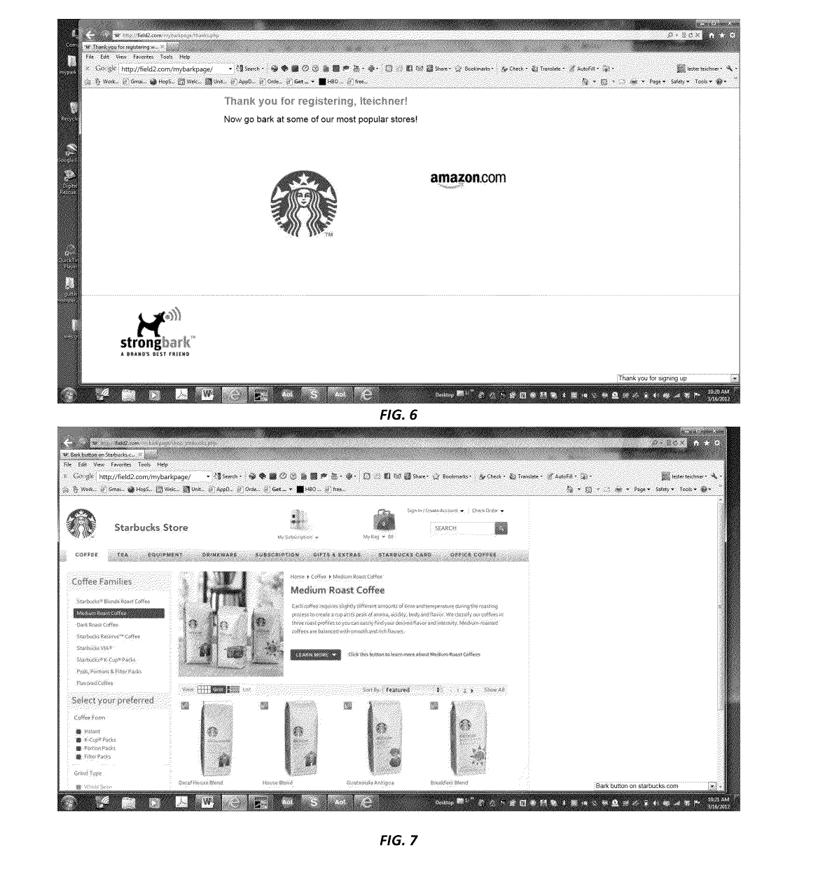

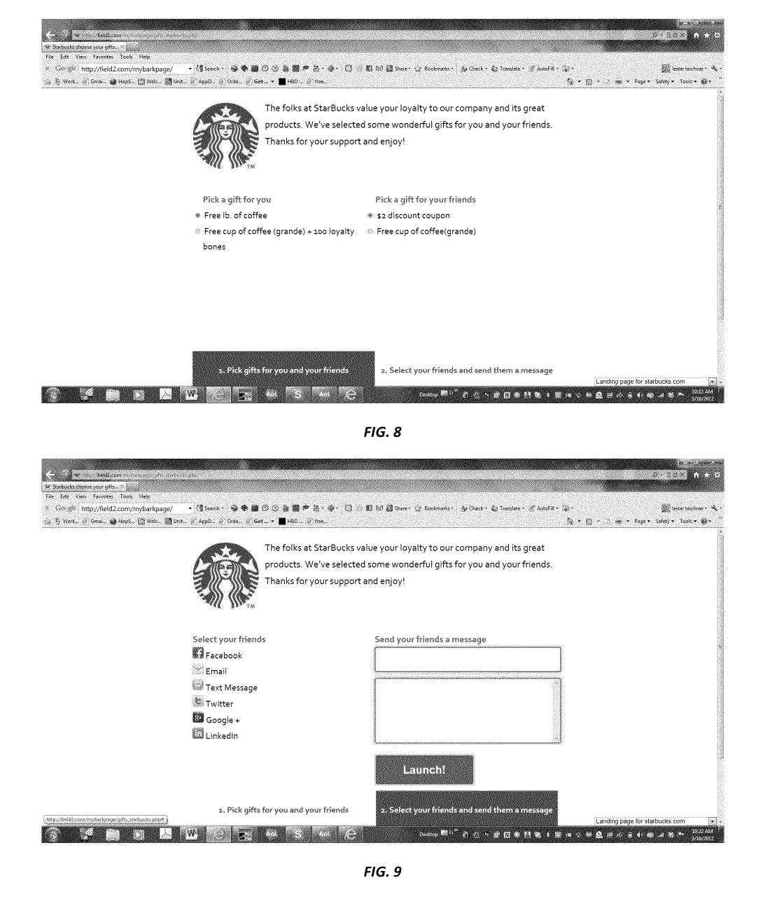

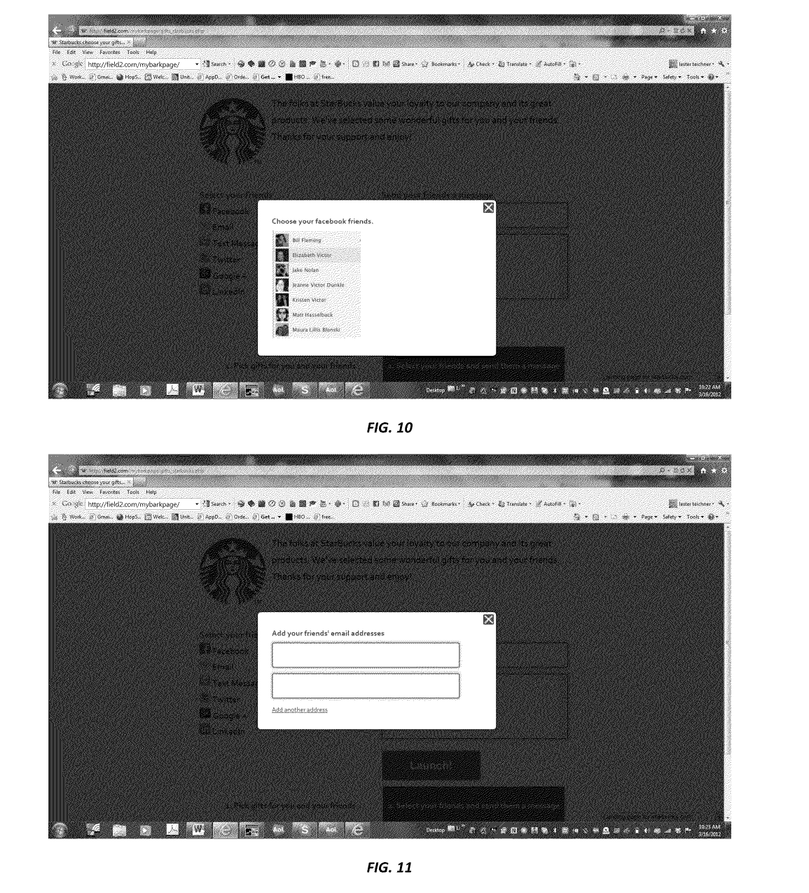

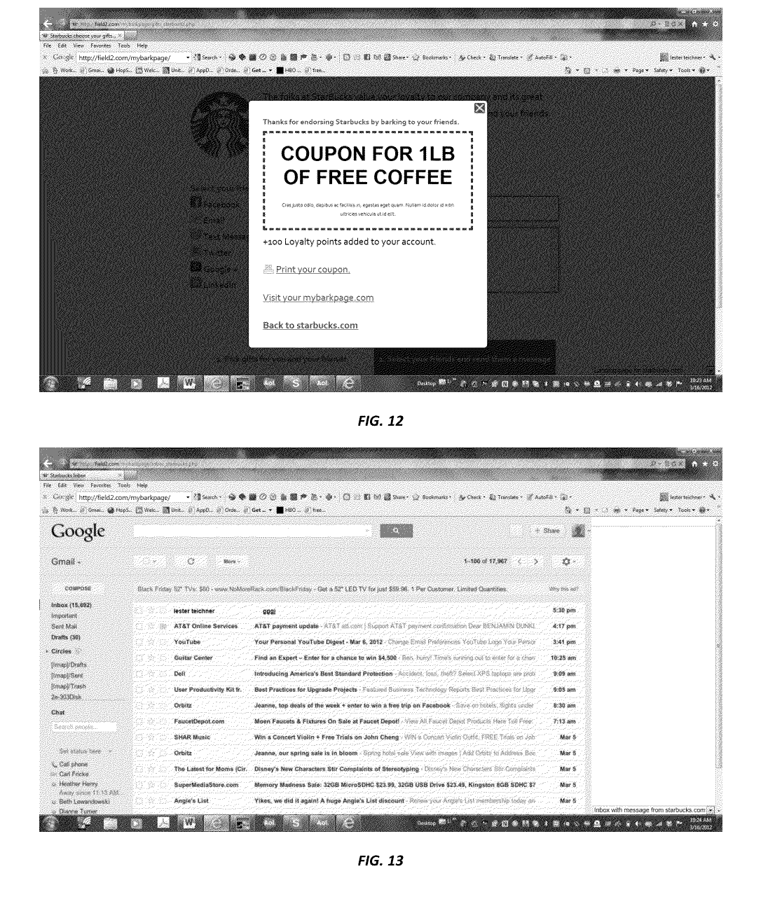

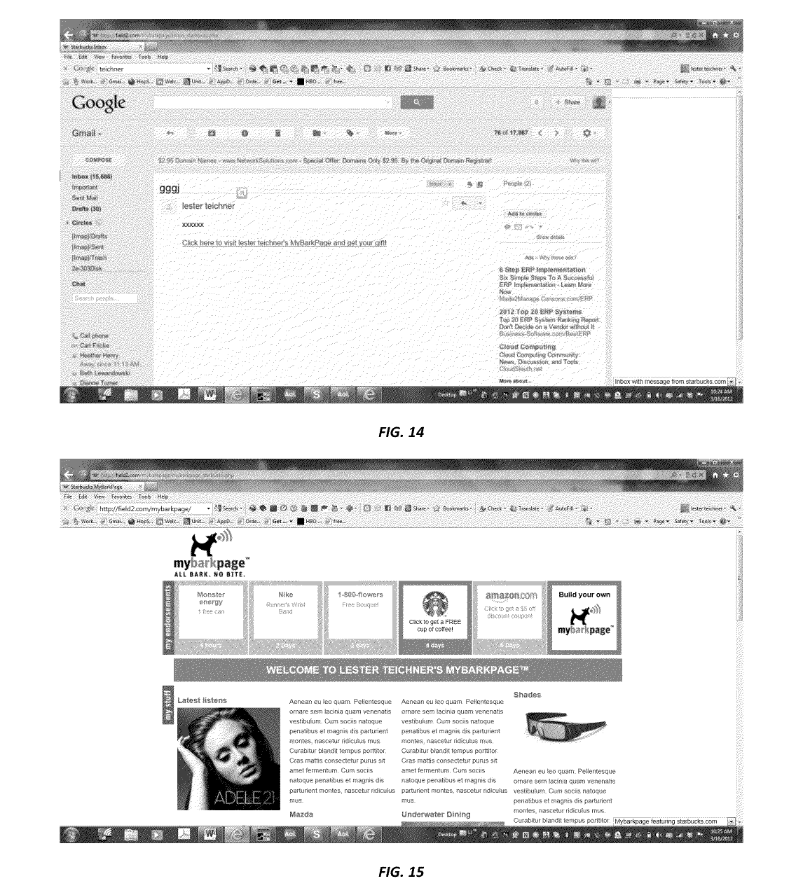

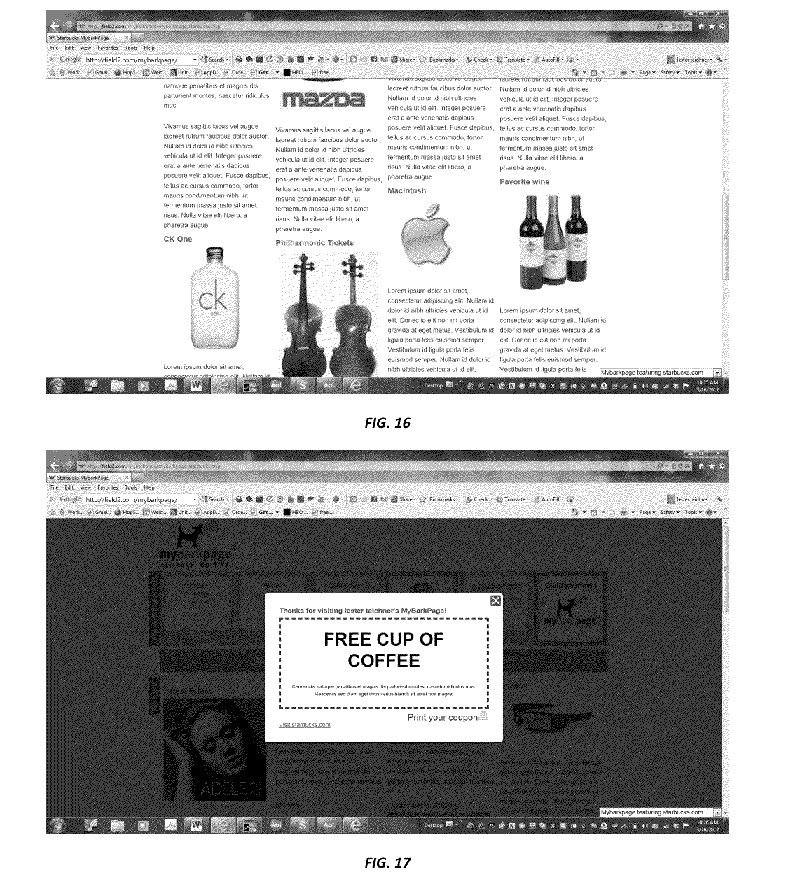

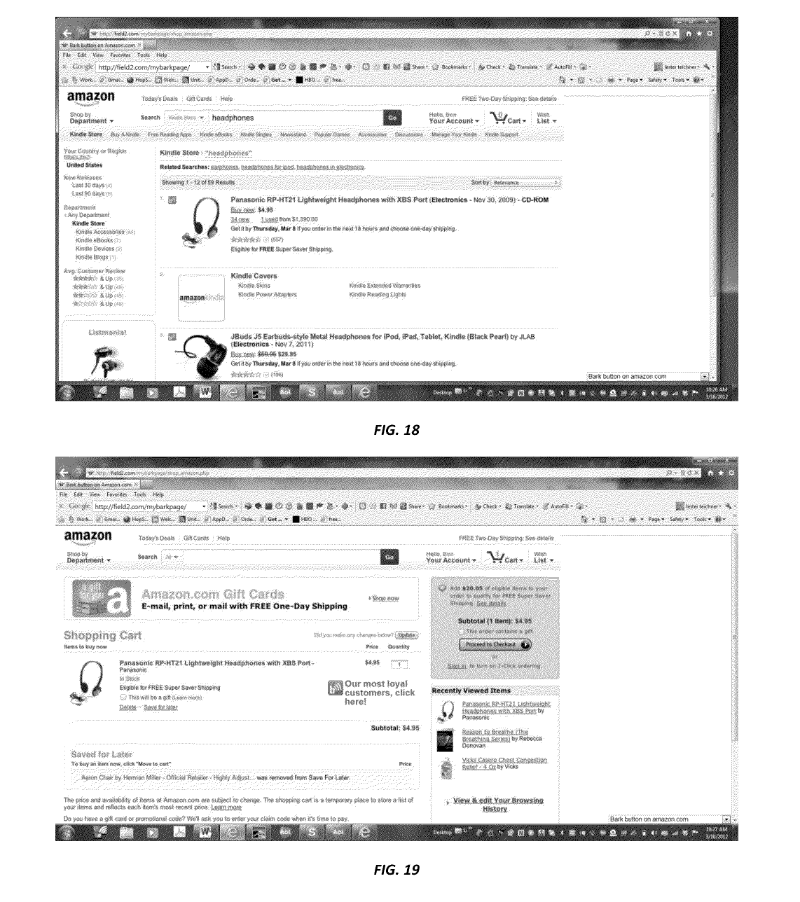

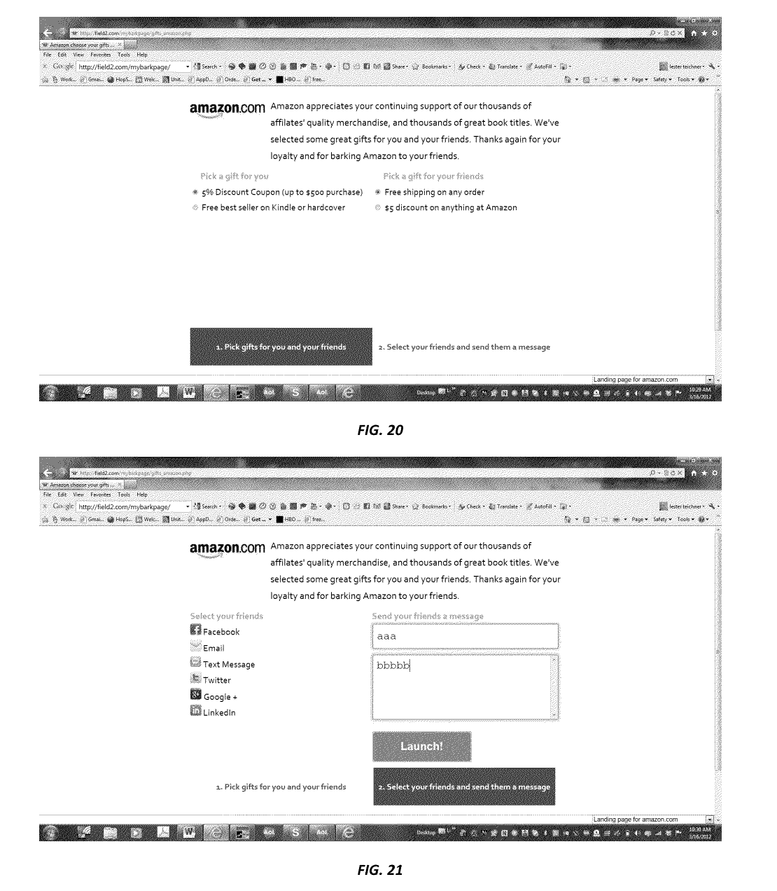

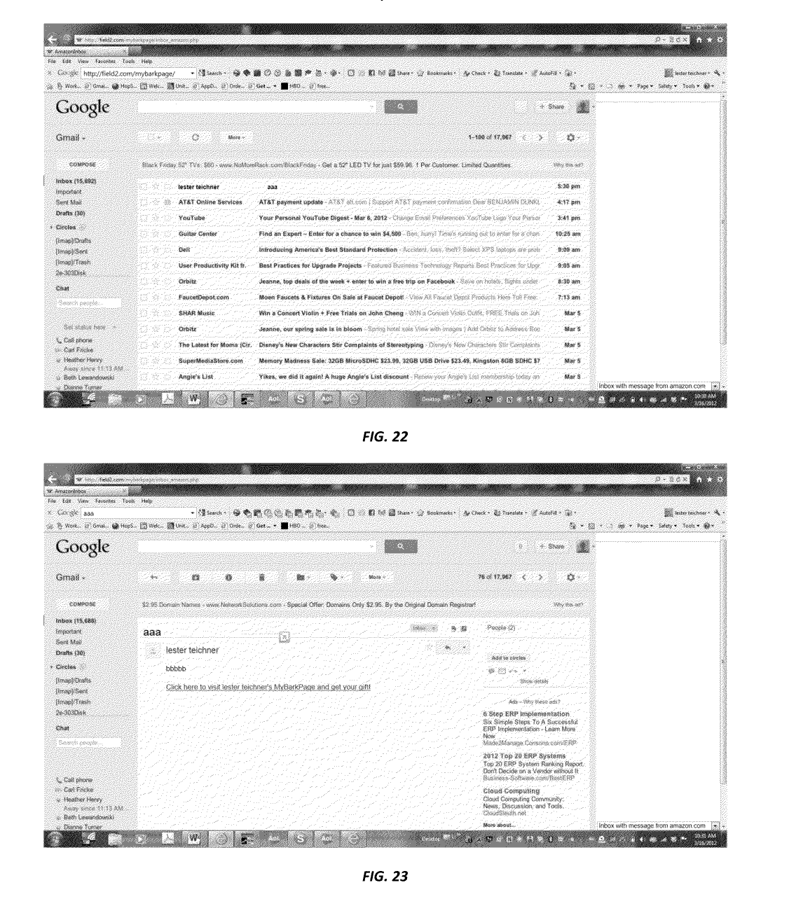

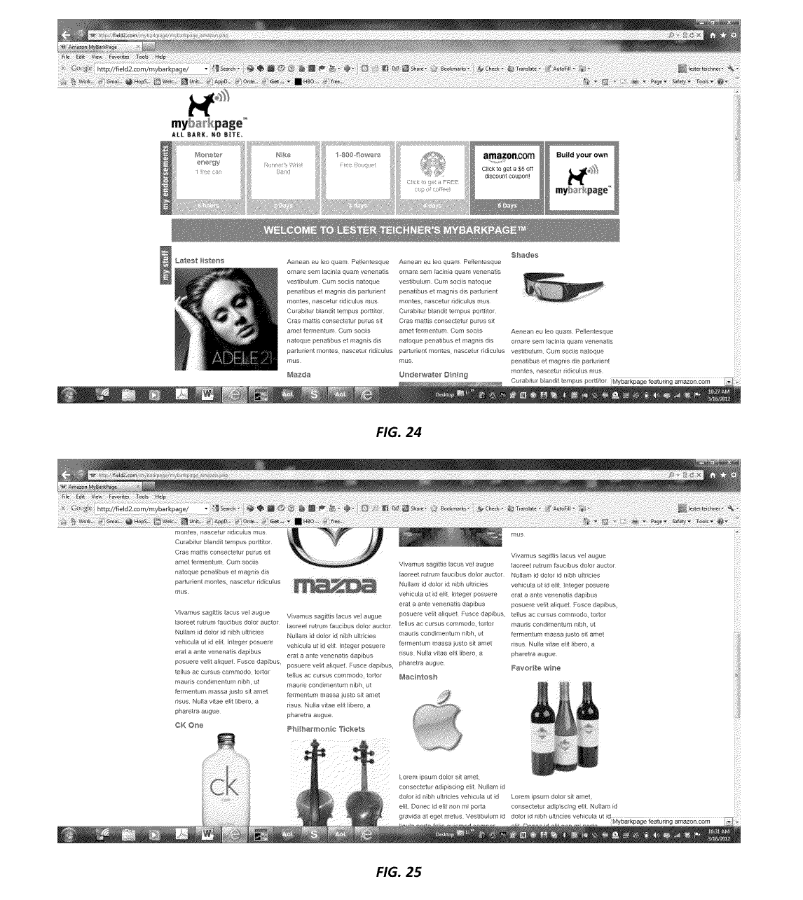

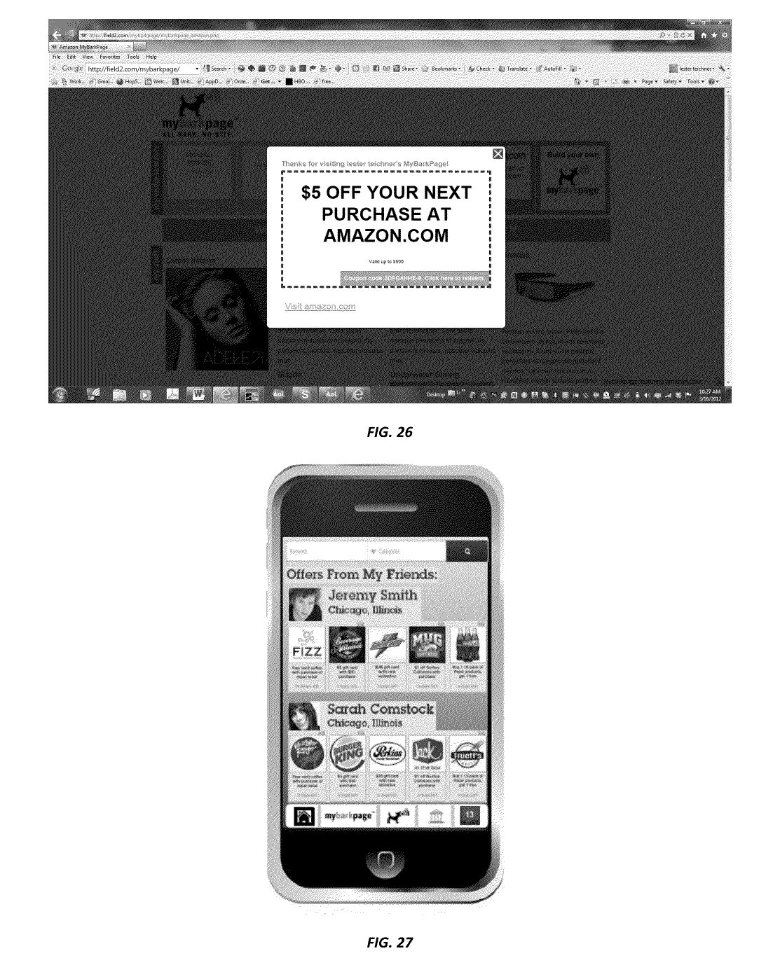

FIG. 4 illustrates an example process diagram for performing a method 400 of enabling an endorser to distribute referrals to selected contacts within a trusted environment. In step S401, the endorser may access an owner website 105 and select a product or service to promote. In step S403, the endorser depresses a referral button 107 that re-directs the endorser from the owner website 105 to a trusted environment 110. In step 405, the endorser may access the endorser interface engine 112 that selects incentives, offers, and contacts. In step 407, the endorser interface engine 112 redirects the endorser to a messaging application 120 that enables the endorser to generate a private and personal message for dissemination to the selected contacts. In step 409, the referral server 340 disseminates the personal referral message to at least one contact and provides a URL within the personal referral to direct a browser associated with a device to the page 200. In step 411, the endorser interface engine 112 provides incentive data to the endorser's page 200 for display. The incentive data may include a time period for promoting the product or service. As discussed herein, the incentive data may be based on selection of the at least one communication network, the product, a number of selected contacts, and the time period for promoting the product. The incentive data may include an incentive offer for the endorser a gift for the at least one contact. In step 413, a determination is made whether the user is an endorser. If the user is an endorser, then the endorser is re-directed in step S 415 from the owner's website 105 to the trusted environment 110 to redeem incentives. Upon completing the redemption process, the endorser is returned to the owner's website 105 or another selected website in step S417. Alternatively, if the user is not an endorser, then the user is re-directed in step S419 from the endorser's page 114 within the trusted environment 110 to an owner's website 105 associated with the incentives to redeem incentives. Upon completing the redemption process, the user is returned to the endorser's page 114 or another selected website in step S421.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media.

For an exemplary embodiment, the system provides a method of enabling an endorser to disseminate referrals to selected contacts within a familiar and trusted environment, including the steps of: selecting, via a processor, an item to promote at an owner website; selecting a link at the owner website to enter the trusted environment; selecting at least one contact; selecting parameters at the trusted environment; generating incentive data based on the selected parameters; displaying the incentive data at a webpage associated with a selected Uniform Resource Locator; selecting a messaging application to generate a personal message to the selected at least one contact; and providing the Uniform Resource Locator within the personal message to direct a browser associated with the at least one contact to enter the trusted environment.

In another feature for an exemplary embodiment, the feature may include the addition of parameters related to a time period, at least one incentive, and at least one contact offer.

In another feature for an exemplary embodiment, the feature may include a Uniform Resource Locator associated with the endorser.

For an exemplary embodiment, the system provides a method of distributing referrals, including the steps of: receiving, via a network communication, a request to select an item to promote at an owner website; receiving, via the network communication, a command from the owner website to enter the trusted environment; receiving, via the network communication, a request to select at least one contact; receiving, via the network communication, a request to select parameters at the trusted environment; receiving, via the network communication, a command to generate incentive data based on the selected parameters; receiving, via the network communication, a request to display the incentive data at webpage associated with a selected Uniform Resource Locator; receiving, via the network communication, a request to select a messaging application to generate a personal message to the selected at least one contact; and receiving, via the network communication, a request to provide the Uniform Resource Locator within the personal message to direct a browser associated with the at least one contact to enter the trusted environment.

For an exemplary embodiment, the platform provides a system and method for enabling a brand owner to generate, via a template one or more promotions such that an endorser may engage a gateway to those promotions from any medium to disseminate referrals to selected contacts for such promotions within a familiar, trusted environment. The system includes the ability to make a selection of a promotion provided by a brand owner to enter the trusted environment. The endorser selects at least one contact and parameters at the trusted environment. The trusted environment generates or provides incentive data based on the selected parameters and displays the incentive data, that may be normalized for contacts related to an endorser at a webpage, accessible via a selected Uniform Resource Locator. Within the trusted environment, a messaging application is utilized to generate a personal message associated with the selected at least one contact and provides the Uniform Resource Locator within the personal message to direct a browser associated with the at least one contact to enter the trusted environment. Upon entering the trusted environment, a contact may interact with incentive data associated with various endorsers, and may also be returned outside of the trusted environment. The endorser, upon accepting a promotion from a brand owner and disseminating referrals to selected contacts, may similarly be returned outside of the trusted environment.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments, or in mobile or other connectivity environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multiprocessor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of distributing information, the method comprising:
providing access to a trusted environment using a gateway to a referral server, wherein the trusted environment includes a referral server;
processing a first message by the referral server, wherein the first message promotes a first site and provides information capable of providing access to the trusted environment;
processing a second message by said referral server, wherein the second message includes information related to a first offer for an endorser;
receiving access information associated with an endorser, whereby the endorser is permitted to gain access to said trusted environment;
processing a third message by said referral server, wherein the third message relates to a second offer associated with said trusted environment and identified by the endorser;
receiving access credentials associated with an individual other than the endorser, whereby the individual other than the endorser is permitted to gain access to said trusted environment;
processing a response to said third message by said referral server indicating a selection of the second offer by an individual other than the endorser.

2. The method of claim 1, further comprising:
processing a criteria message associated the first offer by said referral server, wherein the criteria message includes information selected from a group consisting of pre-selected criteria, including a length of time the endorser agrees to exclusively market the product or owner, a number of contacts the endorser selects to market to, social networks the user selects to market through, a celebrity status, prior marketing effectiveness, personal demographics, usage history, and real-time bidding.

3. The method of claim 1, further comprising the step of:
processing a plurality of third messages by said referral server, to normalize for display.

4. The method of claim 1, further comprising the step of:
processing a return address link associated with the first offer for an endorser, whereby the return address link provides information to return the endorser to a location prior to accessing the controlled environment.

5. The method of claim 1, further comprising the step of:
processing a first responsive message associated with said second message, wherein the first responsive includes information concerning a selection related to the first offer for an endorser.

6. The method of claim 1, further comprising the step of:
processing a return address link associated with the second offer by an individual other than the endorser, whereby the return address link provides information to return the individual other than the endorser to a location prior to accessing the controlled environment.

7. The method of claim 1, wherein the step of processing a second message by said referral server, further comprises:
wherein the information related to a first offer for an endorser is optimized for display on a mobile device;

8. The method of claim 1, wherein the step of processing a third message by said referral server, further comprises:
wherein the third message is optimized for display on a mobile device.

9. A system for distributing information, the system comprising:
an endorser connected through an endorser device to a trusted environment, wherein the trusted environment includes a referral server;
a message generated by the referral server, wherein the message promotes an owner site and provides access to the trusted environment;
an incentive provided to the endorser by the referral server to transmit the message to a at least one contact available through a contact device;
a trusted environment communications module, wherein the trusted environment communications module transmits the message to the at least one contact;
a contact communications module, wherein the contact communications module receives the message which includes access for the at least one contact to the trusted environment and an incentive for the at least one contact to enter the trusted environment.

10. The system of claim 9, further comprising:
a redemption module within the trusted network, wherein the redemption module allows the at least one contact to redeem the incentive provided to the at least one contact by the owner site.

11. The system of claim 9, further comprising:
a redemption module within the trusted network, wherein the redemption module allows the endorser to redeem the incentive provided to the at least one contact by the owner site.

12. The system of claim 9, wherein the incentive provided to the endorser is selected from the group consisting of pre-selected criteria, including a length of time the endorser agrees to exclusively market the product or owner, a number of contacts the endorser selects to market to, social networks the user selects to market through, a celebrity status, prior marketing effectiveness, personal demographics, usage history, and real-time bidding.

13. A system for distributing information, the system comprising:
a message generating module, whereby the message generating module processes data that forms a portion of a message associated with a branded message;
an endorser development module, in communication with the message generating module, whereby the endorser development module processes data that forms a portion of a message associated with a endorser message;
a promotion module, in communication with the endorser development module, whereby the promotion module processes data that is associated with the selection of said endorser message;
a redemption module, in communication with the server communication module, whereby the redemption module processes data that is associated with the selection of an incentive message.

14. A system for distributing information, the system comprising:
a communication gateway, whereby the communication gateway provides a secure access connection to a trusted environment;
a referral server, whereby the referral server may be accessed through the trusted environment, for communication with at least one module containing data associated with a promotion;
an owner development module, the owner development module processing information associated with the promotion, the owner development module further comprising a template to receive data associated with said promotion to be established by a promoter for said promotion;
an endorser module, in communication with the owner development module, whereby the endorser module processes information associated with said promotion directed to an endorser; and
a redemption module, in communication with said owner development module, whereby the redemption module processes information associated with a second promotion established by the endorser.

15. The system for distributing information of claim 14, further comprising:
a third promotion whereby the third promotion is normalized to have a similar relative appearance with respect to the second promotion.

16. The system for distributing information of claim 14, further comprising:
a third promotion whereby the third promotion has a shape distinct in proportion to the relative appearance of the second promotion.
